(19) United States
(12) Patent Application Publication
(10) Pub. No.: US 2007/0163629 A1
(43) Pub. Date: Jul. 19, 2007

(54) Cleaning of a furnace

(75) Inventor: Georg Bruendermann, Thuine (DE)

Correspondence Address: BROOKS KUSHMAN P.C., 1000 TOWN CENTER, TWENTY-SECOND FLOOR, SOUTHFIELD, MI, 48075, US

(73) Assignee: Georg Bruendermann, Thuine (DE)

(21) Appl. No.: 10/595,114

(22) PCT Filed: Sep. 1, 2004
(86) PCT No.: PCT/DE04/01931

§ 371 Date: Feb. 21, 2006

(30) Foreign Application Priority Data
Sep. 2, 2003 (DE) 103407901

(51) Int. Cl. B08B 3/00; B08B 9/00; B08B 3/12

(52) U.S. Cl. 134/166 C; 134/166 R; 134/167 R; 134/167 C; 134/172

(57) ABSTRACT

The invention relates to a device (1) for cleaning a flue of a combustion system. Said device (1) comprises a nozzle head (8) that is located in a flue (2) during the cleaning process and directs a cleaning medium onto interior walls (9) of the flue (2) and/or against pipes which are arranged therein, a hose (5) that conducts the cleaning medium, is connected to the nozzle head (8), and can be introduced into the flue (2) such that the position of the nozzle head (8) in the flue can be adjusted, and a hose drum (4) for winding up or unwinding the hose (5). The inventive device (1) is characterized in that the hose drum (5) is mounted so as to be rotatable about a first axis (11) and a second axis. The angle of rotation of the nozzle head (8) in the flue (2) is varied by rotating the hose drum (4) about said two axes, and so is the vertical height of the nozzle head (8) if the hose (4) is introduced into the flue (2) from above.

The invention relates to a device for cleaning a flue of a combustion system.

A device for cleaning a flue is known from EP 1 291 698 A1, in which a hose is inserted into the flue from above. The hose is wound onto a hose drum. In order to insert the tube farther into the flue in the vertical direction, the hose drum is rotated about its axis, so that the hose is unwound from the hose drum.

Mounted on the end of the hose located in the flue is a nozzle head with several nozzles pointing in different directions. The nozzles serve to spray water, fed through the hose to the nozzle head, against interior walls of the flue, or pipes located therein. The surfaces in question are intended to be cleaned by the impact of the water jets.

So that the interior surfaces of the flue, or the pipes or heat exchangers located therein, are cleaned over their entire vertical height, if at all possible, the height of the nozzle head in the flue is varied during the cleaning process. Moreover, the nozzle head is connected to the hose in rotating fashion. An impeller driven by the flow of the water causes the nozzle head to rotate by means of a gearbox. The impeller and the gearbox are located in the nozzle head in this context. The rotation of the nozzle head ensures that the interior walls of the flue are cleaned all around in a horizontal plane.

Since the impeller and the gearbox are located in the nozzle head, the design of the nozzle head is complex and expensive. In addition, the design must take into account the fact that the nozzle head is exposed to high temperatures in the flue. This is particularly true when the supply of the water cooling the nozzle head is interrupted during the cleaning process due to a malfunction.

Failure of the impeller or the gearbox in the nozzle head can have serious consequences. The nozzle head can no longer rotate in this case. The water jets emerging from the nozzle head are then stationary and locally expose individual areas of the interior surfaces of the flue to the pressure of the water over an extended period of time. This can result in relatively major damage being caused to the areas of the flue in question, or to the pipes installed therein, especially since failure of the impeller or the gearbox during the cleaning process is generally not detected.

A similar cleaning device is known from EP 1 256 761 A2. A “circular deflection nozzle” is provided as the nozzle head and is said to guarantee rotationally symmetrical water delivery, such that all areas of the interior surfaces of the flue are said to be sprayed with water in a horizontal plane, even without rotation of the nozzle head.

Owing to the rotationally symmetrical structure of the deflection nozzle, a water jet emerges from the nozzle head that is of equal size, or equal strength, on all sides. In the case of a non-circular flue, such as a rectangular flue, the interior surfaces are thus cleaned to different degrees by a rotationally symmetrical water jet. The distance between the nozzle head and the surface to be cleaned varies as a function of the structural design of the flue. In the case of flues of narrow design, the distance between the nozzle head and the long side can be considerably smaller than the distance between the nozzle head and the short side. It is impossible, or very difficult, to set a water pressure that ensures adequate cleaning, on the one hand, and does not damage the flue, on the other hand. In addition, the flue can display pipes, inspection ports and other internals that require special cleaning and for which all-round cleaning with rotationally symmetrical water delivery from the nozzle head is not suitable.

The object of the invention is to provide a device for cleaning a flue that operates efficiently, very largely rules out damage to the flue, requires little space and can easily be used in existing combustion systems with flues.

The object is solved by providing a device with the characteristics of claim 1. In this context, the hose drum is mounted so as to be rotatable at least about a first axis, corresponding to the drum axis, and about a second axis. The result of rotation about this second axis, which is not parallel to the drum axis, is that the hose, or the hose section located in the flue during the cleaning process, is rotated about its longitudinal axis. The nozzle head is connected to the hose in non-rotating fashion, meaning that rotation of the hose drum about the second axis results in the nozzle head likewise being rotated in the flue.

As a result of rotation of the hose drum about the first axis, i.e. about the drum axis, the hose is unwound or wound up, meaning that the position of the nozzle head in the flue can be varied simultaneously with the rotation of the nozzle head. If the hose is inserted into the flue from above, the vertical height and the angle of rotation of the nozzle head in the flue can thus be adjusted.

In the case of an essentially torsion-proof hose, the rotation of the nozzle head can be accurately defined by rotating the hose drum about the second axis. This opens up the possibility of specifically defining the direction of a cleaning jet emerging from the nozzle head by rotating the hose drum. In combination with rotation of the hose drum about the first axis, this thus permits pinpointed cleaning of individual elementary areas in the interior of the flue. The geometry of the flue, particularly the distance between the nozzle head and the surface to be cleaned, the internals located in the flue, and also possibly different degrees of dirt accumulation, can be taken into account during cleaning by individually setting the period of time for which, and/or the frequency with which, a cleaning jet hits a certain area. Water is preferably used as the cleaning medium.

The hose drum is preferably held by a drum carrier. The hose drum can rotate about the first axis in reference to the drum carrier. The drum carrier, in turn, is mounted so as to be rotatable about the second axis. Rotation of the drum carrier thus results in the nozzle head mounted on the hose being rotated about the longitudinal axis of the hose.

In a preferred practical example, the first axis and the second axis are perpendicular to each other. The drum axis is preferably horizontal and the second axis vertical. This kind of arrangement of the two axes rules out any influence of rotation of the hose drum about the second axis on the vertical height of the nozzle head suspended from the hose in the flue when the hose located in the flue is suspended from above.

It is expedient if the hose can be inserted into the flue through an opening having an essentially vertical axis that is coaxial to the second axis of the hose drum or to the axis of rotation of the drum carrier. The preferably heat-resistant hose, which is flexible but torsion-proof in the longitudinal direction, can thus easily be inserted into the flue without having to be bent unnecessarily.

In a preferred practical example, rotation of the hose drum about the first and second axes is controlled. Based on the given geometrical conditions (e.g. diameter of the hose drum, distance of the hose drum from the flue), regulation of the rotation of the hose drum permits control of the position (the vertical height in the case of a suspended hose) and rotational angle of the nozzle head. Given a known geometry of the nozzle head (e.g. arrangement and direction of the nozzles), it is thus possible to determine how long and with which frequency certain areas in the interior of the flue are cleaned. For example, particularly dirty areas can be exposed to the water jet for longer and more frequently, while other areas can be completely omitted as required.

The pressure of the water (of the cleaning medium) can also preferably be controlled in the hose or the nozzle head. By specifying corresponding target values, it is possible, for example, to reduce the pressure as a function of the vertical position and rotational angle of the nozzle head when a water jet hits a surface located in close proximity to the nozzle head. If a surface more distant from the nozzle head is to be cleaned, however, the target value for the pressure can be increased. As a result, every elementary area in the flue that can be reached by a water jet of the nozzle head can be cleaned individually in terms of pressure, duration and frequency.

The rotational movements of the hose drum, and thus the spatial position and the rotational angle of the nozzle head in the flue, are preferably pre-programmed. In this context, a control unit of the cleaning device can encompass a memory that stores target values for the rotational movements of the hose drum, and also for the pressure values of the cleaning medium. Comparison of these target values with actual values determined, for example, by water pressure measurement, hose length measurement and rotational angle measurement for the drum carrier, permits automatic operation of the device according to the invention.

A first servomotor can be provided for rotating the hose drum about the first axis. A second servomotor can be used to rotate the hose drum about the second axis. The two servomotors can be controlled by the control unit in accordance with the specified target values.

The nozzle head can display several nozzles. The nozzles are preferably arranged in such a way that the reaction forces of the cleaning medium emerging through the nozzles balance out in a horizontal plane. This can, for example, be achieved by the nozzle head displaying several nozzles that are spaced apart at equal distances in the circumferential direction and directed radially outwards. In this context, the axis of a nozzle in operating position of the nozzle head can also have a vertical component.

The hose drum can be infinitely rotatable about the second axis, meaning that the hose drum can rotate about the second axis any number of times. Alternatively, the hose drum can be rotatable about the second axis only over a certain angular range, e.g. over an angular range of 180°. With this angular range, at least two nozzles, arranged diametrically in the nozzle head, are preferably to be provided. When the hose drum is rotated back and forth over the given angular range, the two nozzles together cover an angular range of 360°, meaning that a flue can be cleaned all round in a horizontal plane when using a suspended hose. A further practical example provides for an angular range of 90°, in which context the nozzle head encompasses at least four nozzles.

In a practical example, a device for guiding or retaining the nozzle head can be provided on the nozzle head or on one end of the hose. In this context, the nozzle head preferably displays an eye, by means of which a rope or the like can be fastened to the nozzle head.

With the help of the rope, which pulls the nozzle head in a predefined direction with a preferably adjustable force, the hose can be held in a desired position and, insofar as the control of the hose drum permits, guided on a desired path. As a result, it is possible, for example, for a hose that is passed horizontally into the flue through a lateral opening to be held in the horizontal plane by the tension force of the rope.

The invention is described in more detail below, based on a practical example illustrated in the drawings. The Figures show the following:

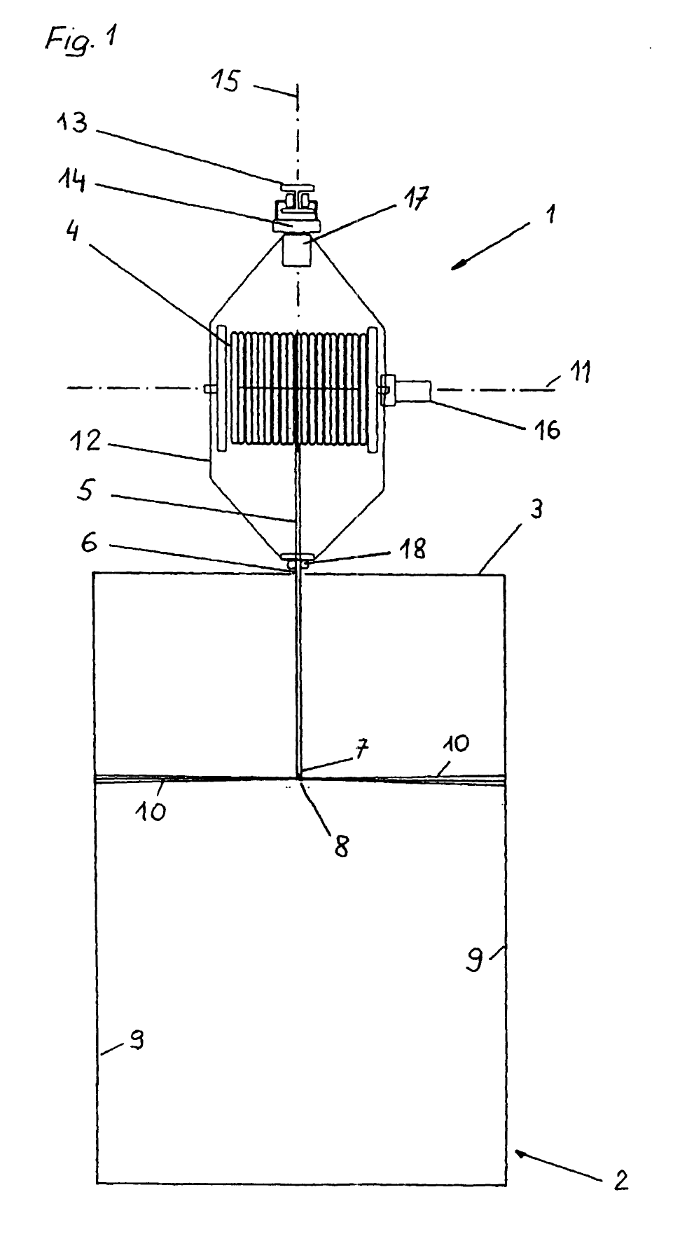

FIG. 1 A practical example of the device according to the invention, with a schematically illustrated flue, and

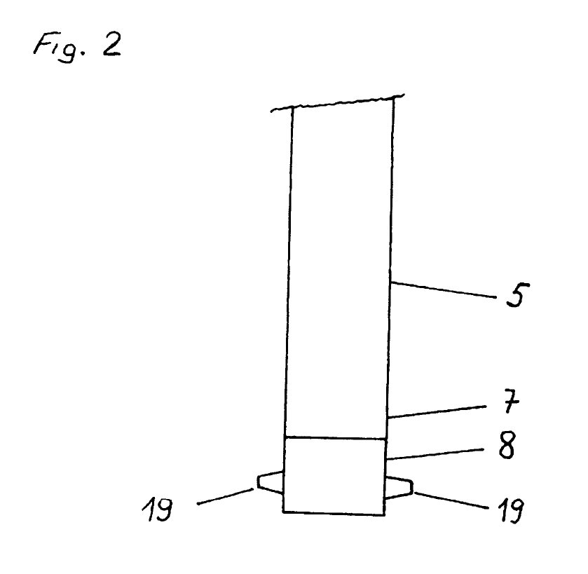

FIG. 2 A hose with a nozzle head.

FIG. 1 shows a device 1 for cleaning a flue 2. Flue 2 is only illustrated schematically as a cuboid here. Located on an upper end 3 of flue 2 is device 1 with a hose drum 4, on which a hose 5 is partially wound up. Hose 5 passes through an opening 6 in flue 2. The hose is made of heat-resistant material and cannot be twisted, or only insignificantly, in its longitudinal direction.

A nozzle head 8 is fastened in non-rotating fashion on one end 7 of hose 5, which is located in flue 2. The task of nozzle head 8 is to direct a cleaning medium, preferably water, that is passed through hose 5 into flue 2 onto interior walls 9 of flue 2 at a certain pressure. Two water jets 10 emerge from nozzle head 8 and hit interior walls 9 of flue 2.

Hose drum 4 is held horizontally by a drum carrier 12. By rotating hose drum 4 about a first axis 11, which corresponds to the drum axis, hose 5 is unwound or wound up, such that the vertical height of nozzle head 8 in flue 2 changes.

Device 1 is suspended from an I-beam 13, which extends in the drawing plane of FIG. 1. Device 1 can be displaced along I-beam 13, in order to be positioned above a flue (not shown) that can be located alongside flue 2. Device 1 can thus be used to clean several flues of a combustion system simply by displacing it along I-beam 13.

A suspension device 14, which connects device 1 to I-beam 13, permits rotation of drum carrier 12 about a second axis 15, which runs vertically and perpendicularly to first axis 11. As a result of rotation of drum carrier 12 about second axis 15, nozzle head 8 suspended from hose 5 is likewise rotated about the vertical within flue 2, the consequence being that water jets 10 are also rotated in flue 2.

A first servomotor 16 is provided for rotating hose drum 4 about first axis 11, while a second servomotor 17 rotates drum carrier 12 about second axis 15. The two servomotors 16, 17 are controlled via a control unit (not shown). In this way, the servomotors are controlled in such a manner that interior surfaces 9 of flue 2 are cleaned according to an individual cleaning pattern. Certain areas can be omitted in this context, while other areas can be cleaned for longer and more frequently.

Not shown in FIG. 1 is a water supply unit, which is connected to hose drum 4. The water supply unit encompasses a pressure controller, so that the pressure at which the water emerges from nozzle head 8 can be adjusted. In this context, the pressure can be a function of the vertical height and the rotational angle of nozzle head 8 in flue 2.

FIG. 2 shows hose 5, which is connected to nozzle head 8 in non-rotating fashion at hose end 7. Nozzle head 8 encompasses two nozzles 19, which are directed radially outwards and spaced 180 degrees apart in the circumferential direction. With a nozzle head of this kind, a capacity of drum carrier 12 for rotation over an angular range of 180° is sufficient for performing all-round cleaning in a horizontal plane.

### Cleaning of a Furnace

### LIST OF REFERENCE NUMBERS

1 Device
2 Flue
3 Top end
4 Hose drum
5 Hose
6 Opening
7 End
8 Nozzle head
9 Interior wall
10 Water jet
11 First axis
12 Drum carrier
13 I-beam
14 Suspension device
15 Second axis
16 First servomotor
17 Second servomotor
18 Hose guide
19 Nozzle

1. Device for cleaning a flue or the like of a combustion system, comprising:
a nozzle head, which is located in the flue during the cleaning process and directs a cleaning medium onto the interior walls of the flue and/or onto pipes located therein,
a hose carrying the cleaning medium, which is connected to the nozzle head and can be inserted into the flue such that the position of the nozzle head in the flue can be adjusted,
a hose drum, for winding up and unwinding the hose,
characterised in that the hose drum is mounted so as to be rotatable at least about a first axis and a second axis.

2. Device according to claim 1, characterised in that the hose drum is held so as to be rotatable about the first axis by a drum carrier, which is mounted so as to be rotatable about the second axis.

3. Device according to claim 1, characterised in that the two axes are perpendicular to each other.

4. Device according to claim 1, characterised in that the second axis is essentially vertical.

5. Device according to claim 1, characterised in that the hose can be inserted into the flue through an opening having an essentially vertical axis that is coaxial to the second axis.

6. Device according to claim 1, characterised in that the rotation of the hose drum about the first axis and second axis is controllable.

7. Device according to claim 1, characterised in that the pressure of the cleaning medium can be adjusted in the hose or in the nozzle head.

8. Device according to claim 7, characterised in that the pressure is adjustable as a function of the rotational angle of the hose drum about the two axes.

9. Device according to claim 1, characterised in that the rotational movements about the first axis and about the second axis can be pre-programmed.

10. Device according to claim 2, characterised in that a first servomotor is provided for rotating the hose drum about the first axis, and a second servomotor for rotating the drum carrier about the second axis.

11. Device to according to claim 1, characterised in that the nozzle head displays several nozzles that are spaced apart at equal distances in the circumferential direction and directed radially outwards.

12. Device according to claim 11, characterised in that the hose drum can be rotated back and forth about the second axis over an angular range, where the angular range is no smaller than the angular distance between the nozzles in the circumferential direction.

13. Device according to claim 1, characterised in that a device for guiding or retaining the nozzle head is provided on the nozzle head or no one end of the hose.

14. Device according to claim 13, characterised in that the nozzle head displays an eye or the like for fastening a tensioning rope.
